(19) United States
(12) Patent Application Publication
(10) Pub. No.: US 2007/0178793 A1
(43) Pub. Date: Aug. 2, 2007

(54) Wood panel with water vapor-permeable polyester layer

(76) Inventor: Brian Christopher Gerello, Statham, GA (US)

Correspondence Address: Carlos Nieves, Esq.;J.M. Huber Corporation, 333 Thornall Street, Edison, NJ, 08837-2220, US

(21) Appl. No.: 11/341,829

(22) Filed: Jan. 27, 2006

(51) Int. Cl. B32B 27/12; B32B 15/04; B32B 7/12; B32B 21/10; D04H 1/00; D04H 13/00; D04H 3/00; D04H 5/00

(52) U.S. Cl. 442/394; 442/413; 442/414; 428/354; 428/351

(57) ABSTRACT

Disclosed is a panel comprising a nonwoven polyester water vapor-permeable layer having a moisture vapor transmission rate of less than 5 perms attached to an underlying engineered wood board.

### BACKGROUND OF THE INVENTION

The walls of a residential or commercial building are typically constructed by attaching several panels to the studs of an underlying supporting structural frame; the panels are placed edge-to-edge with each panel contacting the edges of adjacent panels. An additional layer, known as a water-resistive barrier, is then wrapped and secured to the wall panels. Common water-resistive barrier materials include building paper, asphalt felt and a variety of polymeric “housewraps”. Popular materials for this purpose include the Tyvek® product available from the Dupont Corporation, Wilmington, Del., and the Typar product from Reemay, Inc., Old Hickory Tenn.

Constructing a wall in this manner has the advantage of requiring the efforts of only a few workers at a time, and the use of this “house wrap” barrier material “house wrap” provides additional protection by protecting the wall from moisture penetration and additionally reduces the air loss from infiltration. However, while this barrier material provides additional protection against water penetration, it has the disadvantage of being difficult and time-consuming to install because the paper or wrap must first be unrolled and spread over the wall surface and then secured to the aforementioned wall panels. If this wall wrap paper were attached to the wall panels during manufacture then the additional step of attaching the wrapping paper to the panels after the installation of the panels could be avoided along with the occasional need to reinstall or reattach the wall wrap paper when it is damaged during construction by inclement weather.

Accordingly, panels have been developed with the wall wrapping barrier material preapplied during manufacture. Such panels consist, for example, of a polyurethane film applied over an engineered wood composite (such as oriented strand board) having a resin-impregnated kraft paper overlay. This panel construction provides excellent protection against water penetration, particularly where adjacent panels meet to form a sea; and yet because the barrier layers are attached during manufacture, the additional step of applying barrier layers such at Tyvek during building and construction is avoided.

However, there are difficulties in practicing a manufacturing process in which, as in the example above, wall wrapping materials are water vapor-impermeable barrier. Particularly, with the use of a water vapor-impermeable layer it is difficult or even impossible for water vapor, e.g., steam to penetrate through the barrier materials or layers and into the underlying wood board during the pressing stage during manufacture. This is particularly important because in modern processes for manufacturing engineered wood boards, steam-injection pressing is used. Steam-injection helps create a uniform density profile throughout the wood board, thereby enhances the strength performance of the material. By the application of a water vapor-impermeable layer, it is difficult for steam that has been injected into a board to escape the board, which results in blowing or cracking of the panel construction.

Given the foregoing, there is a continuing need to develop an engineered wood board having one or more applied barrier layers, which is capable of being pressed by the use of steam-injection.

### BRIEF SUMMARY OF THE INVENTION

The present invention relates to a panel comprising: a nonwoven polyester water vapor-permeable layer having a moisture vapor transmission rate of less than 5 perms attached to an underlying engineered wood board.

The present invention also relates to a wood panel comprising: an underlying engineered wood board having upper and lower surface layers and a core layer; and a nonwoven polyester water vapor-permeable layer having a moisture vapor transmission rate of less than 5 perms attached to the upper surface layer.

### DETAILED DESCRIPTION OF THE INVENTION

All parts, percentages and ratios used herein are expressed by weight unless otherwise specified. All documents cited herein are incorporated by reference.

As used herein, “wood” is intended to mean a cellular structure, having cell walls composed of cellulose and hemicellulose fibers bonded together by lignin polymer.

By “wood composite material” it is meant a composite material that comprises wood and one or more other additives, such as adhesives or waxes. Non-limiting examples of wood composite materials include oriented strand board (“OSB”), waferboard, particle board, chipboard, medium-density fiberboard, plywood, and boards that are a composite of strands and ply veneers. As used herein, “flakes”, “strands”, and “wafers” are considered equivalent to one another and are used interchangeably. A non-exclusive description of wood composite materials may be found in the Supplement Volume to the Kirk-Othmer Encyclopedia of Chemical Technology, pp 765-810, 6^{th} Edition.

The following describes preferred embodiments of the present invention which provides a panel comprising a nonwoven polyester water vapor-permeable layer having a moisture vapor transmission rate of less than 5 perms attached to an underlying engineered wood board. By selecting and applying a water vapor-permeable barrier layer as an external barrier layer excellent protection against water penetration is provided; while at the same time water vapor (steam) is allowed to pass through the water vapor-permeable barrier layer and either enter or exit the underlying wood board.

The underlying engineered wood board substrate in the present invention may be made from a variety of different materials, such as wood or wood composite materials, such as oriented strand board (“OSB”), which is particularly preferred. The oriented strand board is derived from a starting material that is naturally occurring hard or soft woods, singularly or mixed, whether such wood is dry (having a moisture content of between 2 wt % and 12 wt %) or green (having a moisture content of between 30 wt % and 200 wt %). Typically, the raw wood starting materials, either virgin or reclaimed, are cut into strands, wafers or flakes of desired size and shape, which are well known to one of ordinary skill in the art.

After the strands are cut they are dried in an oven and then coated with a special formulation of one or more polymeric thermosetting binder resins, waxes and other additives. The binder resin and the other various additives that are applied to the wood materials are referred to herein as a coating, even though the binder and additives may be in the form of small particles, such as atomized particles or solid particles, which do not form a continuous coating upon the wood material. Conventionally, the binder, wax and any other additives are applied to the wood materials by one or more spraying, blending or mixing techniques, a preferred technique is to spray the wax, resin and other additives upon the wood strands as the strands are tumbled in a drum blender.

After being coated and treated with the desired coating and treatment chemicals, these coated strands are used to form a multi-layered mat, preferably a three layered mat. This layering may be done in the following fashion. The coated flakes are spread on a conveyor belt to provide a first ply or layer having flakes oriented substantially in line, or parallel, to the conveyor belt, then a second ply is deposited on the first ply, with the flakes of the second ply oriented substantially perpendicular to the conveyor belt. Finally, a third ply having flakes oriented substantially in line with the conveyor belt, similar to the first ply, is deposited on the second ply such that plies built-up in this manner have flakes oriented generally perpendicular to a neighboring ply. Alternatively, but less preferably, all plies can have strands oriented in random directions. The multiple plies or layers can be deposited using generally known multi-pass techniques and strand orienter equipment. In the case of a three ply or three layered mat, the first and third plys are surface layers, while the second ply is a core layer. The surface layers each have an exterior face. In the present invention the water vapor-permeable layer is affixed to the exterior surface of each of the surface layers.

The above example may also be done in different relative directions, so that the first ply has flakes oriented substantially perpendicular to conveyor belt, then a second ply is deposited on the first ply, with the flakes of the second ply oriented substantially parallel to the conveyor belt. Finally, a third ply having flakes oriented substantially perpendicular with the conveyor belt, similar to the first ply, is deposited on the second ply.

Various polymeric resins, preferably thermosetting resins, may be employed as binders for the wood flakes or strands. Suitable polymeric binders include isocyanate resin, urea-formaldehyde, polyvinyl acetate (“PVA”), phenol formaldehyde, melamine formaldehyde, melamine urea formaldehyde (“MUF”) and the co-polymers thereof. Isocyanates include diphenylmethane-p,p′-diisocyanate group of polymers, which have NCO-functional groups that can react with other organic groups to form polymer groups such as polyurea, —NCON—, and polyurethane, —NCOO—; a binder with about 50 wt % 4,4-diphenyl-methane diisocyanate (“MDI”) or in a mixture with other isocyanate oligomers (“pMDI”) may be used. A suitable commercial pMDI product is Rubinate 1840 available from Huntsman, Salt Lake City, Utah, and Mondur 541 available from Bayer Corporation, North America, of Pittsburgh, Pa. Suitable commercial MUF binders are the LS 2358 and LS 2250 products from the Dynea corporation.

After the multi-layered mats are formed according to the process discussed above, they are compressed under a hot press machine, making use of a steam-injection process; the hot press machine fuses and binds together the wood materials, binder, and other additives to form consolidated OSB panels of various thickness and sizes. The high temperature also acts to cure the binder material. Preferably, the panels of the invention are pressed for 2-15 minutes at a temperature of about 175° C. to about 240° C. The resulting composite panels will have a density in the range of about 35 lbs/ft³ to about 48 lbs/ft³ (as measured by ASTM standard D1037-98). The thickness of the OSB panels will be from about 0.6 cm (about ¼″) to about 3-4 cm (about 1.5″).

As mentioned above, in the present invention a water vapor-permeable layer is adhered to an underlying engineered wood composite. The water vapor-permeable layer is made from a nonwoven polyester that has a thickness of 0.015 inches to about 0.032 inches, and a moisture vapor transmission rate (as determined by ASTM E 96/96B-05, Procedure B) of less than about 5 perms (less than about 35 g/m²/day). Suitable commercial specimens of nonwoven polyester are available from the Dupont Corporation, Wilmington, Del., and from Reemay, Inc., Old Hickory Tenn.

Optionally an adhesive may be used to bond the water vapor-permeable layer to the engineered wood board. This adhesive is preferably selected from phenolic, epoxy, and polyurethane resins, which are described above. Additionally, the steam used in the steam injection process promotes the adherence of a sufficiently porous, water vapor-permeable layer to an underlying wood board.

The invention will now be described in more detail with respect to the following, specific, non-limiting examples.

### EXAMPLE 1a (PRESENT INVENTION)

Wood panels with a nonwoven polyester water vapor-permeable layer adhered to the surface of the panel in a primary process, were produced with the following parameters relating to the content of the starting wood strand materials for the panels: moisture content of 7 wt % to 9 wt %, resin concentration of 5 wt %, and wax concentration of 1.5 wt %. The panels were then pressed using a steam-injection process and a press temperature of 400° F., for a press time of 175 seconds, under a pressure of 200 psi.

### EXAMPLE 1b (PRIOR ART)

A separate set of panels were produced, these panels were identical to those in Example 1a, except that for these panels, a water vapor-impermeable kraft paper overlay was attached to the surface of the panels in a primary process.

With respect to Examples 1a, and 1b, it was noticed that the paper overlay did not adhere to the wood panels in Example 1b because an insufficient amount of steam penetrated into the paper overlay. By contrast in Example 1a, the nonwoven polyester water vapor-permeable layer adhered very well to the wood panels because a sufficient amount of steam was able to penetrate into the wood layers.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A panel comprising: a nonwoven polyester water vapor-permeable layer having a moisture vapor transmission rate of less than 5 perms attached to an underlying engineered wood board.

2. The panel according to claim 1, wherein the water vapor-permeable film layer has a thickness of about 0.015 inches to about 0.032 inches.

3. The panel according to claim 1, further comprising an adhesive resin applied to an exterior surface of the underlying engineered wood board.

4. The panel according to claim 3, wherein the adhesive resin is selected from the group comprising phenolic, epoxy, and polyurethane resins.

5. A wood panel comprising:
an underlying engineered wood board having upper and lower surface layers and a core layer; and
a nonwoven polyester water vapor-permeable layer having a moisture vapor transmission rate of less than 5 perms attached to the upper surface layer.

6. The panel according to claim 5, wherein the water vapor-permeable film layer has a thickness of about 0.015 inches to about 0.032 inches.

7. The panel according to claim 5, further comprising a second water vapor-permeable film layer attached to the lower surface layer.

8. The panel according to claim 7, wherein the second water vapor-permeable film layer has a thickness of about 0.015 inches to about 0.032 inches.

9. The panel according to claim 7, wherein the second water vapor-permeable film layer is attached to an exterior surface of the lower surface layer using an adhesive resin, and the water vapor-permeable film layer is attached to an exterior surface of the upper surface layer using an adhesive resin

10. The panel according to claim 7, wherein the adhesive resin is selected from the group comprising phenolic, epoxy, and polyurethane resins.
